(19) United States
(12) Patent Application Publication
(10) Pub. No.: US 2026/0018996 A1
(43) Pub. Date: Jan. 15, 2026

(54) SWITCHED-CAPACITOR CONVERTER WITH POWER DELIVERY REGULATION

(71) Applicants: Silicon Mitus, Inc., Seongnam-si (KR); Hangzhou Silicon-Magic Semiconductor Technology Co., Ltd., Hangzhou City (CN)

(72) Inventors: Kyoung Sik Seol, Seoul (KR); Hyeon Seon Yu, Yongin-si (KR); Ho Jun Jang, Seongnam-si (KR)

(73) Assignees: Silicon Mitus, Inc., Seongnam-si (KR); Hangzhou Silicon-Magic Semiconductor Technology Co., Ltd., Hangzhou City (CN)

(21) Appl. No.: 19/265,327

(22) Filed: Jul. 10, 2025

(30) Foreign Application Priority Data
Jul. 10, 2024 (KR) 10-2024-0091385

(51) Int. Cl. H02M 3/07

(52) U.S. Cl. CPC H02M 3/07

(57) ABSTRACT

A switched-capacitor converter with power delivery regulation, includes: a switched-capacitor module having switches and capacitors, converting an input voltage into an output voltage according to a conversion ratio corresponding to a coupling structure of the capacitors generated through switching switches; a control voltage generator that generates a control voltage by comparing a preset reference value with a feedback signal selected from an input current flowing to the switched-capacitor module, an output current, and an output voltage of the switched-capacitor module; and a upper switch turn-on resistance regulator that creates a regulated voltage applied to a gate terminal of an upper switch by adjusting a drive voltage for driving the upper switch according to the control voltage, adjust ON-resistance of the upper switch by applying the regulated voltage to the gate terminal to control a gate-source voltage, and regulates power delivered by the switched-capacitor module through an adjustment of the ON-resistance.

### CROSS-REFERENCE TO RELATED APPLICATIONS

This application claims the benefit of Korea Patent Application No. 10-2024-0091385, filed on Jul. 10, 2024, which is incorporated herein by reference for all purposes as if fully set forth herein.

### TECHNICAL FIELD

The present disclosure relates to a switched-capacitor converter with power delivery regulation. More specifically, according to the present disclosure, it relates to a switched-capacitor converter with power delivery regulation that can prevent an overvoltage and an overcurrent from being applied to a battery connected to an output terminal of the switched-capacitor converter, and adjust the input current that flows into a converter by adaptively regulating power delivered to an output terminal of a switched-capacitor converter through the ON voltage adjustment of the upper switch constituting a switched-capacitor converter.

### BACKGROUND

A switched-capacitor converter is a DC-DC converter that converts the voltage using charging and discharging of a capacitor.

A switched-capacitor converter has the advantage of being compact, light-weight, low-cost, and highly efficient as it uses a capacitor instead of an inductor. Furthermore, a switched-capacitor converter can be used in various forms of electronic devices as it can be easily integrated using a CMOS process.

The advantages of switched-capacitor converters will be explained in more detail as follows.

Switched-capacitor converters can be implemented in a smaller size and lighter weight. That is, since a switched-capacitor converter uses a capacitor instead of an inductor, its volume and weight are greatly reduced, making it suitable for small electronic devices.

Switched-capacitor converters can be implemented at low cost. That is, the manufacturing cost is lower as a switched-capacitor converter does not require an inductor.

Switched-capacitor converters are effective. That is, switched-capacitor converters offer high efficiency as they have fewer switching losses and resistance elements. Especially, switched-capacitor converters maintain high efficiency within a range of low output current.

Switched-capacitor converters have a fast transient response that they provide a quick response performance for transient fluctuations due to their fast switching speeds.

Switched-capacitor converters have low output noise. That is, there is low output noise since there are no inductors included in switched-capacitor converters.

Switched-capacitor converters can easily be integrated. That is, as a switched-capacitor converter can be easily integrated using a CMOS process, they can be embedded in various IC components.

Meanwhile, if a high input voltage unintentionally flows into a switched-capacitor converter due to a variety of factors, it may cause damage to the battery connected to the output terminals or internal components of the converter.

The main challenges that can occur in batteries connected to the output terminal of a switched-capacitor converter will be described below.

There is a problem of battery damage due to overvoltage. That is, if the input voltage exceeds the rated voltage (maximum operating voltage) of batteries, batteries may be damaged and, in severe cases, batteries can explode or burst into flames.

In addition, a high voltage may cause damage to battery electrodes, leading to problems such as an increase in the internal resistance, shortened lifespan, and battery capacity decreases.

In addition, a high input voltage can cause overheating of batteries and converters, leading to problems such as shorted lifespan and performance degradation of batteries.

In addition, even if a battery is not in overcurrent or overvoltage conditions, there is a case where the input current should be limited to the prescribed value. Unfortunately, known switched-capacitor converters do not provide an efficient technical solution to this problem.

### PRIOR ART DOCUMENT

### Patent Document

(Patent Document 1) Korean Patent Application Publication No. 10-2017-0092605 (published on Aug. 11, 2017, title: A REGULATED HIGH SIDE GATE DRVIDER CIRCUIT FOR POWER TRANSISTORS)

### SUMMARY

The technical problem of the present disclosure is to provide a switched-capacitor converter with power delivery regulation to prevent an overvoltage and an overcurrent from being applied to a battery connected to an output terminal of a switched-capacitor converter and to adjust input current inputted to a switched-capacitor converter by adaptively regulating power delivered to an output terminal of a switched-capacitor converter through the ON voltage adjustment of the upper switch constituting a switched-capacitor converter.

A switched-capacitor converter with power delivery regulation according to the present disclosure comprises a switched-capacitor module comprising a plurality of switches and capacitors, converting an input voltage into an output voltage according to a conversion ratio corresponding to a coupling structure of the plurality of capacitors generated through switching of the plurality of switches; a control voltage generator that generates a control voltage by comparing a preset reference value with a feedback signal selected from an input current flowing to the switched-capacitor module, an output current, and an output voltage of the switched-capacitor module; and an upper switch turn-on resistance regulator that creates a regulated voltage Vreg being applied to a gate terminal of the upper switch by adjusting a drive voltage Vdrv for driving the upper switch according to the control voltage Vc generated by the control voltage generator, adjust an ON-resistance of the upper switch by applying the regulated voltage to the gate terminal of the upper switch to control a gate-source voltage of the upper switch, and regulate power delivered by the switched-capacitor module through an adjustment of the ON-resistance of the upper switch.

The switched-capacitor with power delivery regulation according to the present disclosure further comprises an input switch installed between a drain terminal of the upper switch constituting the switched-capacitor module and an input terminal to which the input voltage is supplied.

In the switched-capacitor converter with power delivery regulation according to the present disclosure, the control voltage generator, when the feedback signal rises exceeding the preset reference value, limits the output voltage and output current or input current of the switched-capacitor module from rising exceeding the set value by lowering the control voltage to adjust the regulated voltage applied to the gate terminal of the upper switch, thereby increasing the on-resistance Ron of the upper switch.

In the switched-capacitor converter with power delivery regulation according to the present disclosure, the switched-capacitor converter with power delivery regulation is embedded in a power-consuming device.

In the switched-capacitor converter with power delivery regulation according to the present disclosure, the switched-capacitor converter with power delivery regulation is installed between an external power source including a charger and a battery embedded in the power-consuming device to prevent an overvoltage and an overcurrent from being applied to the battery due to a rise in voltage supplied by the external power source.

According to the present disclosure, it has an effect of preventing an overvoltage and an overcurrent from being applied to the battery connected to an output terminal of a switched-capacitor converter and of adjusting the ON voltage of the upper switch constituting the switched-capacitor converter by adaptively adjusting the power delivered to the output terminal of the switched-capacitor converter to adjust an input current being applied to the switched-capacitor converter.

### BRIEF DESCRIPTION OF THE DRAWINGS

FIG. 1 is a drawing depicting a switched-capacitor converter with power delivery regulation according to one embodiment of the present disclosure.

FIG. 2 is an exemplary, specific illustration of a switched-capacitor converter with power delivery regulation according to one embodiment of the present disclosure.

FIG. 3 is an exemplary illustration of a switched-capacitor module according to one embodiment of the present disclosure.

FIGS. 4A-5B are exemplary illustrations of a 4:1 voltage conversion operation of a switched-capacitor module illustrated in FIG. 3.

FIGS. 6A-7B are exemplary illustrations of a 3:1 voltage conversion operation of a switched-capacitor module illustrated in FIG. 3.

FIGS. 8A-9B are exemplary illustrations of a 2:1 voltage conversion operation of a switched-capacitor module illustrated in FIG. 3.

It is to be understood that the specific structural or functional description of embodiments of the present invention disclosed herein is for illustrative purposes only and is not intended to limit the scope of the inventive concept but may be embodied in many different forms and not limited to the embodiments set forth herein.

The embodiments according to the concept of the present invention can make various changes and can take various forms, so that the embodiments are illustrated in the drawings and described in detail herein. It should be understood, however, that it is not intended to limit the embodiments according to the concepts of the present invention to the particular forms disclosed, but includes all modifications, equivalents, or alternatives falling within the spirit and scope of the invention.

Unless defined otherwise, all terms including technical and/or scientific terms used herein have the same meaning as commonly understood by one of ordinary skill in the art to which this invention belongs. These terms, such as commonly used predefined terms, have the same meaning as in the related art and should not be construed as ideal or ambiguous unless explicitly defined in this specification.

Hereinafter, after describing the basic principles of the present disclosure first, the embodiments of the present disclosure will be described in detail.

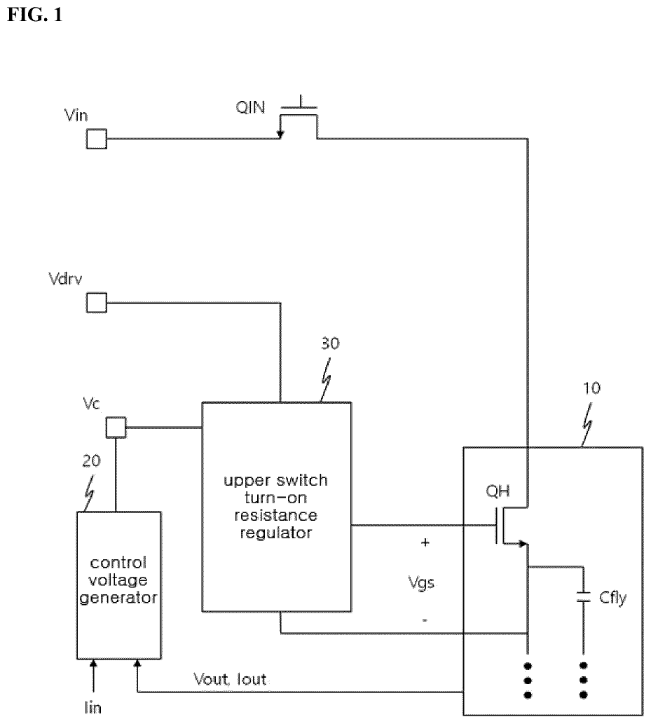

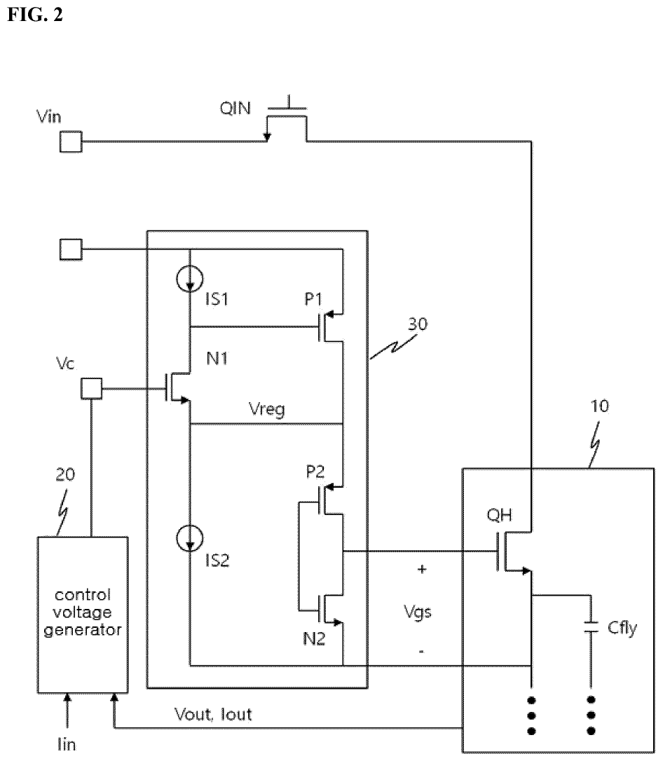

FIG. 1 is a drawing depicting a switched-capacitor converter with power delivery regulation according to one embodiment of the present disclosure, and FIG. 2 is an exemplary, specific illustration of a switched-capacitor converter power delivery regulation according to one embodiment of the present disclosure.

Referring to FIGS. 1 and 2, a switched-capacitor converter with power delivery regulation according to one embodiment of the present disclosure comprises a switched-capacitor module 10, an input switch QIN, a control voltage generator 20, and an upper switch turn-on resistance regulator 30.

In the description below, for example, a switched-capacitor converter with power delivery regulation according to one embodiment of the present disclosure can be embedded in power-consuming devices such as smartphones and tablets.

As a more specific example, a switched-capacitor converter with power delivery regulation according to one embodiment of the present disclosure is installed between an external power source that includes chargers and power-consuming devices such as smartphones and tablets to prevent an overvoltage and an overcurrent from being applied to a battery due to a rise in voltage supplied by the external power source.

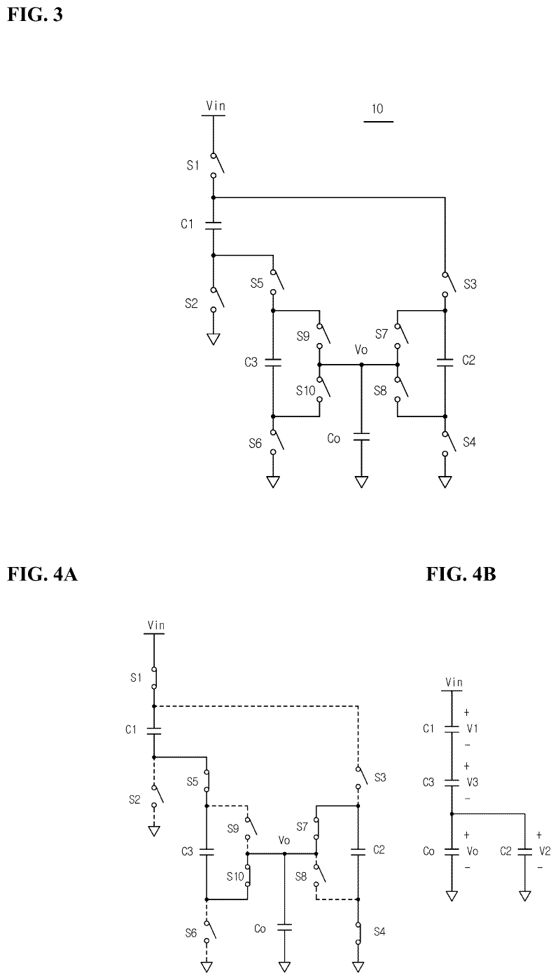

A switched-capacitor module 10 consists of a plurality of switches and capacitors, and converts an input voltage Vin to an output voltage Vout according to a conversion ratio corresponding to a coupling structure of a plurality of capacitors created through switching of a plurality of switches. An exemplary configuration of such switched-capacitor module 10 is described below with reference to FIGS. 3 to 9B. Among a plurality of switches that constitutes a switched-capacitor module 10, the switch closest to the input terminal is the upper switch QH.

The input switch QIN is installed between the input terminal to which the input voltage Vin is supplied and the drain terminal of the upper switch QH which comprises the switched-capacitor module 10. For example, the input switch QIN may serve to regulate the power, to sense currents of the switched-capacitor module 10, and to electrically separate the output terminal connected to the battery and the input terminal. In addition, for example, the input switch QIN may be omitted, however, when the control voltage Vc is generated according to the input current Iin, the input switch QIN can be included as a component for detecting an input current Iin. In addition, for example, the input current Iin can also be sensed by using metallization which is an electrical resistance of a metal wiring that delivers current in a semiconductor device without using an input switch QIN, or by using other generally known means.

The control voltage generator 20 compares a preset reference value with a feedback signal selected from the input currents Iin inputted to the switched-capacitor module 10, the output current Iout, and the output voltage Vout of the switched-capacitor module 10, and generates the control voltage Vc.

For example, when the feedback signal exceeds a set reference value, the control voltage generator 20 drops the control voltage Vc, and adjusts the regulated voltage Vreg applied to the gate terminal of the upper switch QH to limit the output current Iout and output voltage Vout of the switched-capacitor module 10 from exceeding the set value when the ON-resistance Ron of the upper switch QH of the switched-capacitor module 10 is increased.

The upper switch turn-on resistance regulator 30 adjusts a drive voltage Vdrv being supplied to drive the upper switch QH of the switched-capacitor module 10 according to a control voltage Vc generated by the control voltage generator 20 to create a regulated voltage Vreg being applied to the gate terminal of the upper switch QH of the switched-capacitor module 10; regulates the ON-resistance Ron of the upper switch QH of the switched-capacitor module 10 by controlling the gate-source voltage Vgs of the upper switch of the switched-capacitor module 10; and adjusts the power being delivered to a battery or the like by the switched-capacitor module 10 by regulating the ON-resistance Ron of the upper switch QH of the switched-capacitor module 10.

For example, an upper switch turn-on resistance regulator 30 may include a regulator consisting of a super source follower that receives a control voltage Vc and a drive voltage Vdrv, and a gate driver consisting of a CMOS inverter connected to the super source follower, but is not limited to, and any other circuitry can be applied to an upper switch turn-on resistance regulator 30.

As a more specific example, a regulator can include a first current source IS1, a first NMOS switch N1, a second current source IS2, a first PMOS switch P1, and a gate driver can include, but not limited to, a second PMOS switch P2 and a second NMOS switch N2.

A drive voltage Vdrv is applied to one end of the first current source IS1, and one end of the first current source IS1 is connected to a drain terminal of the first PMOS switch P1, and the other end of the first current source IS1 is commonly connected to a drain terminal of the first NMOS switch N1 and a gate terminal of the first PMOS switch P1.

A control voltage Vc output by a control voltage generator 20 is applied to a gate terminal of the first NMOS switch N1, and a drain terminal of the first NMOS switch N1 is commonly connected to the other end of the first current source IS1 and a gate terminal of the first PMOS switch P1, and a source terminal of the first NMOS switch N1 is commonly connected to one end of the second current source IS2 and a source terminal of the first PMOS switch P1 and a drain terminal of the second PMOS switch P2.

One end of the second source IS2 is commonly connected to a source terminal of the first NMOS switch N1, a source terminal of the first PMOS switch P1, and a drain terminal of the second PMOS switch P2, while other end of a second current source IS2 is commonly connected to a source terminal of the second NMOS switch N2 and a source terminal of the upper switch QH constituting the switched-capacitor module 10.

A drive voltage Vdrv is applied to a drain terminal of the first PMOS switch P1; a drain terminal of the first PMOS switch P1 is connected to one end of a first current source IS1; a gate terminal of the first PMOS switch P1 is commonly connected to a drain terminal of the first NMOS switch N1 and the other end of the first current source IS1; and a source terminal of the first PMOS switch P1 is commonly connected to a source terminal of the first NMOS switch N1, one end of the second current source IS2, and a drain terminal of the second PMOS switch P2.

A drain terminal of the second PMOS switch P2 is commonly connected to a source terminal of the first PMOS switch P1, a source terminal of the first NMOS switch N1, and one end of the second current source IS2; a source terminal of the second PMOS switch P2 is commonly connected to a drain terminal of the second NMOS switch N2 and a gate terminal of the upper switch QH constituting the switched-capacitor module 10. In addition, a gate terminal of the second PMOS switch P2 is connected to a gate terminal of the second NMOS switch N2 so that the second PMOS switch P2 and the second NMOS switch N2 constitute a CMOS inverter.

A drain terminal of the second NMOS switch N2 is commonly connected to a source terminal of the second PMOS switch P2 and a gate terminal of the upper switch QH constituting the switched-capacitor module 10; a source terminal of the second NMOS switch N2 is commonly connected to the other end of the second current source IS2 and a source terminal of the upper switch QH that constitutes the switched-capacitor module 10; and a gate terminal of the second NMOS switch N2 is connected to a gate terminal of the second PMOS switch P2.

An exemplary operational configuration of a regulator that can be included in the upper switch turn-on-resistance regulator is described as follows.

As shown in an example of FIG. 2, a regulated voltage Vreg becomes the difference voltage, Vc−Vgs, of a gate-source voltage Vgs of the upper switch QH and the control voltage Vc; when the upper switch QH is turned on, a gate-source voltage Vgs of the upper switch QH becomes a regulate voltage Vreg; and the ON-resistance Ron of the upper switch QH by adjusting the regulated voltage Vreg. When the second PMOS switch connected to the gate of the upper switch QH is turned on, a gate-source voltage Vgs of the upper switch QH becomes the regulated voltage Vreg.

The configuration of a regulator can be implemented in not only a super source follower but also various forms and any other circuitry that can adjust a gate-source voltage Vgs of the upper switch QH according to a control voltage Vc can be implemented.

According to this configuration in one embodiment of the present disclosure, the gate-source voltage of the upper switch QH is adjusted according to the control voltage Vc, and since the ON-resistance Ron of the upper switch QH changes accordingly, the power delivered to the output from the switched-capacitor module 10 can be controlled.

For example, when an input voltage Vin rises for any reason leading to an increase in voltage and current of a battery connected to the switched-capacitor module 10, if a control voltage Vc is lowered, a regulated voltage Vreg is lowered as a result, preventing battery current or voltage from exceeding the set value.

Hereinafter, the configuration and operations of the switched-capacitor module 10 included in the switched-capacitor converter equipped with power delivery regulation according to one embodiment of the present disclosure are exemplarily described with reference to FIG. 3 to FIG. 9B.

FIG. 3 is an exemplary illustration of the switched-capacitor module 10.

The switched-capacitor module 10 can be used to convert power within systems of electronic devices such as smartphones and tablets. In FIG. 3, among a plurality of switches that constitutes the switched-capacitor module 10, the switch S1, which is connected closest to the input terminal, is the upper switch QH.

The switched-capacitor module 10 is capable of receiving an input voltage Vin and providing an output voltage Vo through an output terminal. Here, the input voltage Vin may be a voltage provided by a charger outside the system or a voltage provided by any node in the power network inside the system. The switched-capacitor module 10 creates an input voltage Vin and an output voltage Vo having a predetermined ratio relationship to output any node in the power network inside of the system. An output capacitor Co is also illustrated in FIG. 3, however, the output capacitor Co may be a component of the switched-capacitor module 10 included in the switched-capacitor module 10 or a component outside the switched-capacitor module 10 not included in the switched-capacitor module 10.

The switched-capacitor module 10 can operate to substantially have a 4:1 voltage conversion ratio (the ratio of the output voltage and the input voltage). The switched-capacitor module 10 can substantially, selectively change between a voltage conversion ratio of 4:1, 3:1, or 2:1.

Here, the use of the term ‘substantially’ indicates that the actual ratio of the output voltage and the input voltage may have some errors with respect to 4:1 due to an error of a controller or the parasite elements of circuit devices even if the switched-capacitor module 10 is designed and operated according to a 4:1 voltage conversion ratio. Hereinafter, it should be understood that even if the expression ‘substantially’ is omitted in relation to the voltage conversion ratio or the voltage stress of the device, the above-described error may occur.

Input and output terminals are not particularly limited to a certain form or connection method. Any terminal connected to an input voltage Vin may be understood as an input terminal, and any terminal connected to an output voltage Vo may be understood as an output terminal.

The switched-capacitor module 10 can include a first capacitor C1, a second capacitor C2, a third capacitor C3, and a switch network S1 to S10.

The switch networks S1 to S10 may change the connection relationship between the input terminal, the output terminal, the first capacitor C1, the second capacitor C2, and the third capacitor C3. According to the operation of the switch networks S1 to S10, the voltage conversion ratio may be selected from 4:1, 3:1, or 2:1. According to one or more embodiments, the voltage conversion ratio may be changed during operation of the switched-capacitor module 10.

The circuit configuration of the switched-capacitor module 10 will be described in more detail. The first terminal of the first switch S1 (of the two terminals of the first switch S1, the upper terminal in the drawing is referred to as the first terminal and the lower terminal is referred to as the second terminal. Hereinafter, this applies to other drawings or elements.) is connected to the input terminal, the second terminal of the first switch S1 can be connected to the first terminal of the first capacitor C1 and the first terminal of the third switch S3. The second terminal of the first capacitor C1 can be connected to the first terminal of the second switch S2 and the first terminal of the fifth switch S5. The second terminal of the fifth switch S5 can be connected to the first terminal of the third capacitor C3 and the first terminal of the ninth switch S9. The second terminal of the third capacitor C3 can be connected to the first terminal of the sixth switch S6 and the second terminal of the tenth switch S10. The second terminal of the ninth switch S9 can be connected to the first terminal, output terminal, the second terminal of the seventh switch S7 and the first terminal of the eighth switch S8. The second terminal of the third switch S3 is connected to the first terminal of the seventh switch S7 and the first terminal of the second capacitor C2. The second terminal of the second capacitor C2 is connected to second terminal of the eighth switch S8 and the first terminal of the fourth switch S4. The second terminal of the second switch S2, the second terminal of the sixth switch S6 and the second terminal of the fourth switch S4 can is connected to the reference potential (e.g. ground or earth).

Here, at least one of the first switch S1 to the tenth switch S10 can be connected in series and/or in parallel. In addition, at least one of the first capacitor C1 to the third capacitor C3 can be connected in series and/or in parallel. That is, each of the switches (S1 to S10) and capacitors (C1 to C3) illustrated in FIG. 3 can consist of a plurality of elements to operate as a single element. When referring to the number of switches in the present disclosure, when a plurality of switches connected in series and/or in parallel operate like a single switch, it should be understood that a single switch is used. The same applies to capacitors.

The first switch S1 to the tenth switch S10 can be implemented as a semiconductor switching element. Illustratively, the first switch S1 to the tenth switch S10 can be implemented as semiconductor switching elements capable of high speed operation, such as FETs, IGBTs, MCTs, GTOs, and BJTs.

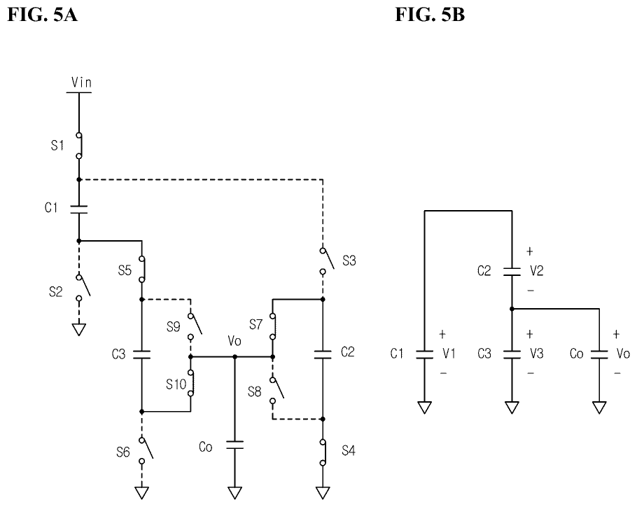

FIG. 4A-5B are drawings for exemplarily describing a 4:1 voltage conversion operation of the switched-capacitor module 10 in FIG. 3.

FIG. 4A depicts switches in a connected state at state 1 in the 4:1 mode, and FIG. 4B equivalently depicts a connection relationship of capacitors at state 1 in the 4:1 mode. FIG. 5A depicts switches in a connected state at state 2 in the 4:1 mode, and FIG. 5B equivalently depicts a connection relationship of capacitors of state 2 in the 4:1 mode.

Referring to FIG. 4A, the first, fourth, fifth, seventh and tenth switches (S1, S4, S5, S7, S10) can be ON, and the second, third, sixth, eighth and ninth switches (S2, S3, S6, S8, S9) can be OFF at state 1 in the 4:1 mode.

In this case, as shown in FIG. 4B, the first terminal of the first capacitor C1 can be connected to the input terminal, the second terminal of the first capacitor C1 is connected to the first terminal of the third capacitor C3, and the second terminal of the second capacitor C2 is connected to the reference potential.

Referring to FIG. 4B, the input voltage Vin, the output voltage Vo, the first capacitor voltage V1, the second capacitor voltage V2, and the third capacitor V3 at state 1 in the 4:1 mode can have the following equation relationship.

$$Vin = V 1 + V 3 + Vo \qquad ( equation 1 )$$

$$V 2 = Vo \qquad ( equation 2 )$$

Referring to FIG. 5A, the second, third, sixth, eighth and ninth switches (S2, S3, S6, S8, S9) can be ON, and the first, fourth, fifth, seventh and tenth switches (S1, S4, S5, S7, S10) can be OFF at state 2 in the 4:1 mode.

In this case, as shown in FIG. 5B, the first terminal of the first capacitor C1 can be connected to the first terminal of the second capacitor C2, the second terminal of the first capacitor C1 is connected to the reference potential, and the second terminal of the second capacitor C2 is connected to the first terminal of the third capacitor C3 and the output terminal, and the second terminal of the third capacitor C3 is connected to the reference potential.

Referring to FIG. 5B, the input voltage Vin, the output voltage Vo, the first capacitor voltage V1, the second capacitor voltage V2, and the third capacitor voltage V3 at state 2 in the 4:1 mode can have the following equation relationship.

$$V 3 = Vo \qquad ( equation 3 )$$

$$V 1 = V 2 + Vo \qquad ( equation 4 )$$

When state 1 and state 2 are being repeated over one switching cycle, the capacitors (C1 to C3) will reach steady state. Assuming that the capacitance is large enough to ignore a change in voltage of capacitors over one switching cycle in a steady state, the capacitor voltages (V1 to V3), the relationship between the input voltage Vin and the output voltage Vo at the steady state can be analyzed from the above equation 1 to equation 4.

The following voltage relationships can be derived from the calculations of the equation 1 to equation 4.

$$V 1 = 2 Vo$$

$$V 2 = V 3 = Vo$$

$$Vin = 4 Vo$$

That is, as the input voltage Vin is four times the output voltage Vo, a voltage conversion ratio of 4:1 can be implemented when the switched-capacitor module 10 shown in FIG. 3 operates as illustrated in FIGS. 4A-5B. Here, the first capacitor voltage V1 is twice the output voltage Vo, the second capacitor voltage V2 and the third capacitor voltage V3 are equal to each of the output voltages Vo respectively. Here, it should be understood that a voltage relationship of capacitors can have the errors mentioned above, and the same may apply to what will be explained below.

The voltage stress that is applied to switches and capacitors when a switched-capacitor module 10 operates at a voltage conversion ratio of 4:1 is shown in the table below.

TABLE

| C1 | C2 | C3 | S1 | S2 | S3 | S4 | S5 | S6 | S7 | S8 | S9 | S10 |
|---|---|---|---|---|---|---|---|---|---|---|---|---|
| 2Vo | Vo | Vo | 2Vo | 2Vo | 3Vo | Vo | Vo | Vo | Vo | Vo | Vo | Vo |

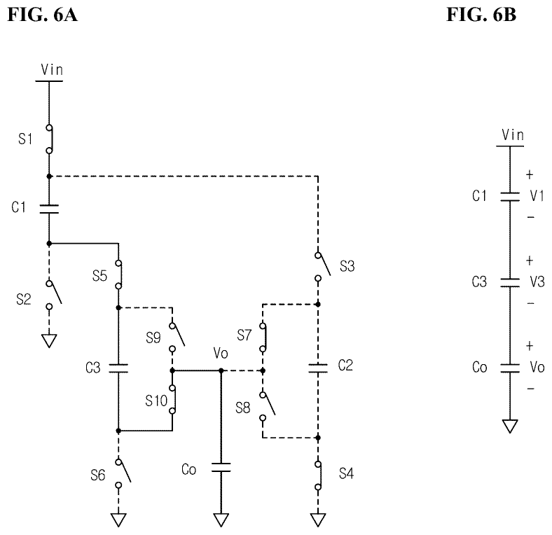

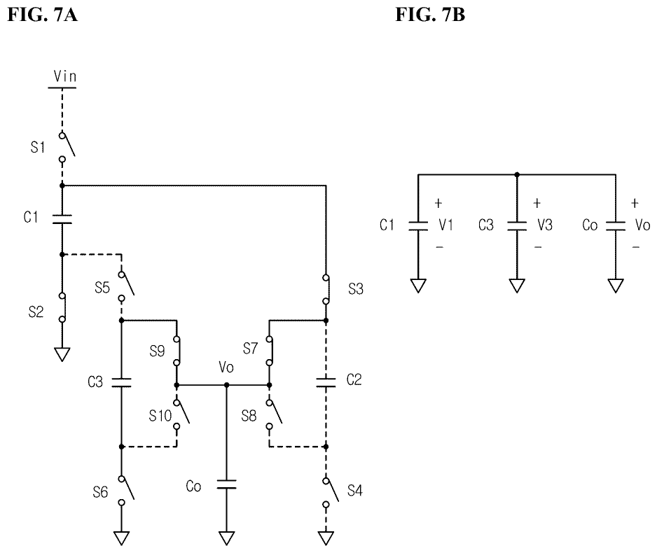

FIGS. 6A-7B are exemplary illustrations of a 3:1 voltage conversion operation of the switched-capacitor module 10 shown in FIG. 3.

FIG. 6A is an exemplary illustration of a connected state of switches at state 1 in the 3:1 mode, and FIG. 6B equivalently depicts a connection relationship between capacitors at state 1 in the 3:1 mode. FIG. 7A is an exemplary illustration of a connected state of the switches at state 2 in the 3:1 mode, and FIG. 7B equivalently depicts a connection relationship between capacitors at state 2 in the 3:1 mode.

Referring to FIG. 6A, the first, fifth, and tenth switches (S1, S5, S10) can be ON, and the second, third, fourth, sixth, seventh, eighth, and ninth switches can be OFF at state 1 in the 3:1 mode.

In this case, as shown in FIG. 6B, the first terminal of the first capacitor C1 is connected to the input terminal, the second terminal of the first capacitor C1 is connected to the third capacitor C3, and the second terminal of the third capacitor C3 is connected to the output terminal.

Referring to FIG. 6B, the third capacitor voltage V3, the first capacitor voltage V1, the output voltage Vo, and the input voltage Vin at state 1 in the 3:1 mode can have the following relationship.

$$Vin = V 1 + V 3 + Vo \qquad ( equation 9 )$$

Referring to FIG. 7A, the second, third, sixth, seventh, and ninth switches (S2, S3, S6, S7, S9) can be ON, and the first, fourth, fifth, eighth, and tenth switches (S1, S4, S5, S8, S10) can be OFF at state 2 in the 3:1 mode.

In this case, as shown in FIG. 7B, the first terminal of the first capacitor C1 and the first terminal of the third capacitor C3 are connected to the output terminal, the second terminal of the first capacitor C1 and the second terminal of the third capacitor C3 is connected to the reference potential.

Referring to FIG. 7B, the input voltage Vin, the output voltage Vo, the first capacitor voltage V1, and the third capacitor voltage V3 at state 2 in the 3:1 mode can have the following relationship.

$$V 1 = V 3 = Vo \qquad ( equation 10 )$$

Solving the equations 9 and 10 yields the following voltage relationship.

$$V 1 = V 3 = Vo$$

$$Vin = 3 Vo$$

That is, as the input voltage Vin is three times the output voltage Vo, a voltage conversion of 3:1 can be implemented when the switched-capacitor module 10 shown in FIG. 3 operates as illustrated in FIGS. 6A-7B. Here, the first capacitor voltage V1 and the third capacitor voltage V3 are equal to each of the output voltages respectively.

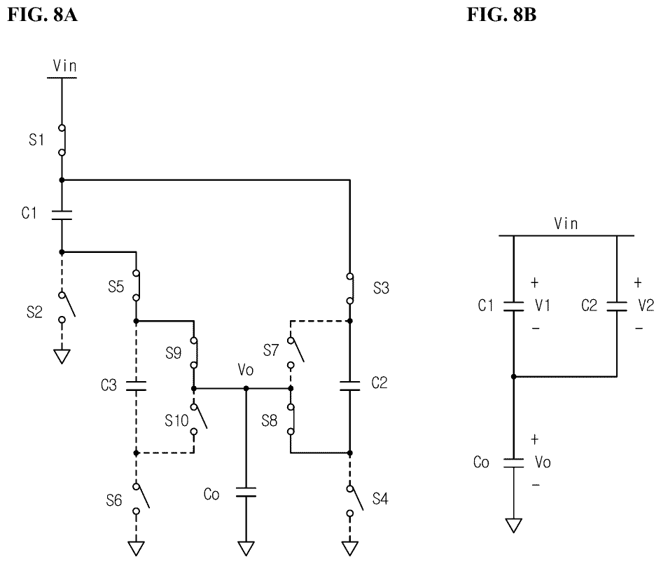

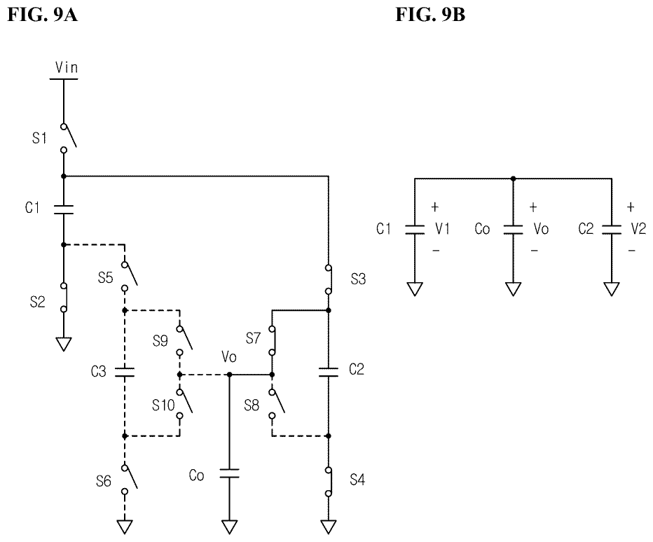

FIGS. 8A-9B are exemplary illustrations of a 2:1 voltage conversion operation of the switched-capacitor module 10 shown in FIG. 3.

FIG. 8A depicts switches in a connected state at state 1 in the 2:1 mode, and FIG. 8B equivalently depicts a connection relationship of capacitors at state 1 in the 2:1 mode. FIG. 9A depicts switches in a connected state at state 2 in the 2:1 mode, and FIG. 9B equivalently depicts a connection relationship of capacitors at state 2 in the 2:1 mode.

Referring to FIG. 8A, the first, third, fifth, eighth, and ninth switches (S1, S3, S5, S8, S9) can be ON and the second, fourth, sixth, seventh, and tenth switches (S2, S4, S6, S7, S10) can be OFF at state 1 in the 2:1 mode.

In this case, as shown in FIG. 8B, the first terminal of the first capacitor C1 and the first terminal of the second capacitor C2 can be connected to the input terminal, and the second terminal of the first capacitor C1 and the second terminal of the second capacitor C2 are connected to the output terminal.

Referring to FIG. 8B, the input voltage Vin, the output voltage Vo, the first capacitor voltage V1, and the second capacitor voltage V2 at state 1 in the 2:1 mode can have the following relationship.

$$Vin = V 1 + Vo \qquad ( equation 11 )$$

$$V 1 = V 2 \qquad ( equation 12 )$$

Referring to FIG. 9A, the second, third, fourth, and seventh switches (S2, S3, S4, S7) are ON and the first, fifth, sixth, eighth, ninth, and tenth switches (S1, S5, S6, S8, S9, S10) are OFF at state 2 in the 2:1 mode.

In this case, as shown in FIG. 9B, the first terminal of the first capacitor C1 and the first terminal of the second capacitor C2 can be connected to the output terminal, and the second terminal of the first capacitor C1 and the second terminal of the second capacitor C2 can be connected to the reference potential.

Referring to FIG. 9B, the input voltage Vin, the output voltage Vo, the first capacitor voltage V1, and the second capacitor voltage V2 at state 2 in the 2:1 model can have the following relationship.

$$V 1 = V 2 = Vo \qquad ( equation 13 )$$

Solving the equation 11 to equation 13 yields the following voltage relationship.

$$V 1 = V 2 = Vo$$

$$Vin = 2 Vo$$

That is, the input voltage Vin is twice the output voltage Vo, a voltage conversion ratio of 2:1 can be implemented when the switched-capacitor module 10 shown in FIG. 3 operates as illustrated in FIGS. 8A-9B. Here, the first capacitor voltage V1 and the second capacitor voltage V2 are equal to each of the output voltages Vo respectively.

In this way, the switched-capacitor module 10 illustrated in FIG. 3 does not require a high withstand voltage capacitor, so it can operate with high efficiency while reducing its size, and also has a voltage conversion ratio of 4:1, 3:1, and 2:1 that can be selected and operated as needed.

As described in detail above according to the present disclosure, when an external input voltage being supplied to the switched-capacitor converter rises unintentionally due to a variety of factors, it has an effect of preventing an overvoltage and an overcurrent from being applied to the battery connected to the output terminal of the switched-capacitor converter by adaptively adjusting power delivered to the output terminal of the switched-capacitor converter through the ON voltage adjustment of the upper switch constituting a switched-capacitor converter.

### DESCRIPTION OF THE REFERENCE NUMBERS IN THE DRAWINGS

10: switched-capacitor module
20: control voltage generator
30: upper switch turn-on resistance regulator
Iin: input current
Iout: output current
Vin: input voltage
Vout: output voltage
Vdrv: drive voltage
Vc: control voltage
Vreg: regulated voltage
QIN: input switch
QH: upper switch
Vgs: gate-source voltage

What is claimed is:

1. A switched-capacitor converter with power delivery regulation, comprising:
a switched-capacitor module comprising a plurality of switches and a plurality of capacitors, configured to convert an input voltage into an output voltage according to a conversion ratio corresponding to a coupling structure of the plurality of capacitors generated through switching of the plurality of switches;
a control voltage generator that generates a control voltage by comparing a preset reference value with a feedback signal selected from an input current flowing to the switched-capacitor module, an output current, and an output voltage of the switched-capacitor module; and
an upper switch turn-on resistance regulator that creates a regulated voltage being applied to a gate terminal of an upper switch by adjusting a drive voltage for driving the upper switch according to the control voltage generated by the control voltage generator, adjusts ON-resistance of the upper switch by applying the regulated voltage to the gate terminal of the upper switch to control a gate-source voltage of the upper switch, and regulates power delivered by the switched-capacitor module through an adjustment of the ON-resistance of the upper switch.

2. The switched-capacitor converter with power delivery regulation of claim 1, further comprising an input switch installed between a drain terminal of the upper switch constituting the switched-capacitor module and an input terminal to which the input voltage is supplied.

3. The switched-capacitor converter with power delivery regulation of claim 1, wherein the control voltage generator, when the feedback signal rises exceeding the preset reference value, limits the output voltage and output current or input current of the switched-capacitor module from rising exceeding a set value by lowering the control voltage to adjust the regulated voltage applied to the gate terminal of the upper switch, thereby increasing the ON-resistance of the upper switch.

4. The switched-capacitor converter with power delivery regulation of claim 1, wherein the switched-capacitor converter with power delivery regulation is embedded in a power-consuming device.

5. The switched-capacitor converter with power delivery regulation of claim 4, wherein the switched-capacitor converter with power delivery regulation is installed between an external power source including a charger and a battery embedded in the power-consuming device to prevent an overvoltage and an overcurrent from being applied to the battery due to a rise in voltage supplied by the external power source.
